(19) United States
(12) Patent Application Publication
(10) Pub. No.: US 2021/0402591 A1
(43) Pub. Date: Dec. 30, 2021

(54) ROBOT ARM

(71) Applicant: GENESIS ROBOTICS AND MOTION TECHNOLOGIES CANADA, Langley (CA)

(72) Inventors: James Brent KLASSEN, Surrey (CA); Christopher ESTERER, Burnaby (CA)

(73) Assignee: GENESIS ROBOTICS AND MOTION TECHNOLOGIES CANADA, Langley, BC (CA)

(21) Appl. No.: 16/497,443

(22) PCT Filed: Mar. 26, 2018
(86) PCT No.: PCT/CA2018/050367

§ 371 Date: Sep. 25, 2019

Related U.S. Application Data
(60) Provisional application No. 62/476,853, filed on Mar. 26, 2017.
(60) Provisional application No. 62/488,809, filed on Apr. 23, 2017.
(60) Provisional application No. 62/489,327, filed on Apr. 24, 2017.
(60) Provisional application No. 62/502,587, filed on May 5, 2017.

(51) Int. Cl. B25J 9/04; B25J 9/12; B25J 19/00; B25J 9/00

(52) U.S. Cl. CPC B25J 9/042; B25J 9/0009; B25J 19/0029; B25J 9/126

(57) ABSTRACT

Robot arms and methods of controlling robot arms. In an example, a hand control is located on a robot arm and provides translation and/or rotation control of actuators that may for example rotate in unison. In another example, a hand control on a robot arm is also provided at an end effector, which may control actuators in the robot arm for example by having the actuators rotate together or oppositely in unison. In a further example, a hand control situated on a robot arm between actuators controls upstream and downstream actuators with different control strategies. In a master slave example, actuators in a master robot control actuators in a slave robot, and the actuators may be provided at an angle and be arranged to hold position in normal operation when unpowered. Nonbackdrivability is also provided by providing sufficient friction between stator and rotor in actuators of a robot arm. In a Scara robot, a fixed part of a base is secured to a floor, while a moving end is supported by a bearing element.

### RELATED APPLICATIONS

This application claims priority to PCT Application No. PCT/CA2018/050367, filed on Mar. 26, 2018, which further claims priority to U.S. Provisional Application No. 62/476,853, filed on Mar. 26, 2017, U.S. Provisional Application No. 62/488,809, filed on Apr. 23, 2017, U.S. Provisional Application No. 62/489,327, filed on Apr. 24, 2017, U.S. Provisional Application No. 62/502,587, filed on May 5, 2017 which are incorporated herein by reference in their entirety.

### TECHNICAL FIELD

Robot arms.

### BACKGROUND

Robot arms with multiple links connected by actuators that have rotation axes at an angle to each other are known from U.S. Pat. No. 7,836,788 (Kamon) and no. 9126332 (L'Ecuyer).

### SUMMARY

There are disclosed novel robot arms and methods of controlling robot arms. In an example, a hand control is located on a robot arm and provides translation and/or rotation control of actuators that may for example rotate in unison. In another example, a hand control on a robot arm is also provided at an end effector, which may control actuators in the robot arm for example by having the actuators rotate together or oppositely in unison. In a further example, a hand control situated on a robot arm between actuators controls upstream and downstream actuators with different control strategies. In a master slave example, actuators in a master robot control actuators in a slave robot, and the actuators may be provided at an angle and be arranged to hold position in normal operation when unpowered. Nonbackdrivability is also provided by providing sufficient friction between stator and rotor in actuators of a robot arm. In a Scara robot, a fixed part of a base is secured to a floor, while a moving end is supported by a bearing element.

### BRIEF DESCRIPTION OF THE FIGURES

Embodiments will now be described with reference to the attached figures, in which like reference characters denote like elements, by way of example.

FIG. 1 shows an exemplary robot arm.

FIG. 2 shows a control diagram for the robot arm of FIG. 1;

FIG. 3 shows an exemplary Scara base for use with the robot arm of FIG. 1;

FIGS. 4A and 4B show stacks of actuators forming a joint for the robot arm of FIG. 1;

FIGS. 5 and 6 illustrate exemplary actuators that may be used in the robot arm of FIG. 1:

FIG. 7 shows a detail of a hand control and arm control that may be used in the robot arm of FIG. 1;

FIGS. 8A and 8B illustrate Scara configurations that may be used in the robot arm of FIG. 1;

FIGS. 9A and 9B show how manual actuators may be used in a variant of the robot arm of FIG. 1:

FIGS. 10A and 10B show a first exemplary wedge design for use in the robot arm of FIG. 1;

FIGS. 11A and 11B show a second exemplary wedge design for use in the robot arm of FIG. 1;

FIG. 12 shows a master slave configuration of robot arms, that may use robot arms as shown in FIG. 1;

FIG. 13 illustrates an angle between actuators in a wedge; and

FIG. 14 shows an actuator using sliding surfaces for producing friction to prevent backdrivability of the actuator.

### DETAILED DESCRIPTION

Immaterial modifications may be made to the embodiments described here without departing from what is covered by the claims. In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims. In the claims, a reference to claims x-y means any one of claims x-y, where x and y are positive integers with x<y.

### Definitions

A robot arm comprises multiple links connected by actuators and extends between ends, such as an end effector and a base. Upstream of an element on the robot arm means closer to the base than the element. Downstream of an element on the robot arm means closer to the end effector than the element.

A link is a part of a robot arm that extends between actuators or between an actuator and the end of a robot arm. The robot arm may work in cooperation with an operator who controls the operation of the robot arm but bears no load. All load may be taken by the robot arm. A robot arm may include a wrist joint, which may be the joint closest to the end effector. A robot arm may include a shoulder joint, which may be the first joint capable of providing lift in the robot arm, nearest to the base of the robot arm. An elbow joint may be a joint between the shoulder and the wrist joint. A forearm or link may be a part of the robot arm between the wrist joint and elbow joint, or between the wrist joint and the shoulder joint. The forearm may be the closest part of the robot arm to the wrist joint.

The actuators may be formed by electric machines, such as an axial flux electric machine. The actuators may be hollow. The actuators may each have a stator and rotor that are integrated with, or directly attached to, adjacent links of the robot arm.

The links of the robot arm may be hollow and may have any suitable shape. Where at least one of the links is connected by at least one of the actuators, the stator or rotor of the actuator may be connected to a first link and the other of the stator or rotor may be connected to a second link. A straight link is a link that extends between actuators having parallel or co-linear axes. An inline link is a link that extends between co-axial actuators.

An end of the robot arm may include the end effector. The end effectors include, but are not limited to an end effector with three fingers for gripping objects.

Another end of the robot arm comprises a base or other point of reference. The base may be fixed to a surface of an object. The object may be a fixed object or a moving object including, but not limited to, a wall, a roof, a floor or another structural element, or a wheeled vehicle.

The robot arm may be operated by a human operator by means of a control device, such as a hand control. The hand control is a device that may be operated by a person's hand to produce control signals corresponding to movement of the robot arm. The hand control is an object shaped to be gripped by the human hand including, but not limited to, a ball, a disk, a handle, a rod, a pedestal or other shaped object that may be gripped by the human hand. The hand control may have multiple degrees of freedom and may include x-y-z translation and rotation about x-y-z axes. Where x-y-z translation is present, x-y may define a horizontal plane while the z axis is vertical. The x axis may correspond to forward and backward movement in relation to the operator, while the y axis may correspond to side to side movement in relation to the operator. Lifting up on the hand control may correspond to movement along the vertical axis. Rotation about the x-y-z axes may correspond to rotation about virtual x-y-z axes that pass through the center of the hand control. The hand control may include additional controls such as a rotary element that encircles a base of the hand control and that provides an additional rotation signal. The hand control may be provided by dual controls that are separated and operated by different hands. For example, one of the dual controls forming the hand control may provide signals corresponding to translation, while the other may provide signals corresponding to rotation. Additional controls may be provided on the hand control such as buttons and levers to provide additional functions. The hand control and additional controls may be provided on a console that is attached to the robot arm. The hand control may comprise a 3D mouse made by 3DConnexion of Boston, Mass., USA, though other hand controls may be used. Details of the hand control are not supplied since such hand controls are known in the art of 3D manipulation of virtual objects.

The acronym SCARA or Scara means Selective Compliance Assembly Robot Arm or Selective Compliance Articulated Robot Arm. A Scara is rigid in the Z-axis and pliable in the XY-axes. By virtue of its parallel-axis joint layout, the Scara is slightly compliant in the X-Y direction but rigid in the ‘Z’ direction, hence the term: Selective Compliant.

An end of a robot arm may comprise a base or end effector. A wedge is defined as a part of robot arm that terminates at opposed ends with rotary actuators, where the rotary actuators have rotation axes that are not co-linear. In some embodiments, the rotation axes of the rotary actuators are not co-planar. In some embodiments, the rotation axes are co-planar and offset from 0 degrees to 90 degrees. In some embodiments, the offset may be 1-10 degrees or 1-5 degrees or 1-2 degrees. Each wedge extends between wedge ends and is bounded by a stator or rotor of respective actuators on each end of the wedge. Each actuator has an axis of rotation and axes of actuators at the end of each wedge are at an angle to each other that defines the wedge angle of the wedge. A stack of actuators may form a joint. Each joint may be operated independently from other joints, or may be operated in unison.

A robot control system may comprise one or more controllers, such as a computing device that may accept control inputs and provide control outputs, and a driver or drivers. The control system receives control signals from the hand control. In some embodiments, for example where there is a one to one correspondence between control signals from the hand control and the actuator, or a set of actuators, driven by a single driver, the controller need only route signals and condition signals so that they may be read by the drivers and to provide proportional signals to the actuators that are controlled in series. The proportions for actuators in series may be stored in a lookup table for fast response. The controllers may comprise general or specific purpose processors with memory, a human interface and display(s).

In some embodiments, where feedback is provided by a force transducer, some more complicated functions may be provided for example using a comparator to decide whether the force exceeds a threshold and generating a stop command to all actuators. In other embodiments, where safety mechanisms are in place, the controller may also sense movements that are beyond a threshold and stop or slow down the actuators. Safety regulations should be taken into account in operation of the robot arm. For example, in jurisdictions where certain types of robots can only be operated where no human is in the robot envelope, then it may not be possible to use a hand control on the robot arm and a master—slave or remote control will be required, possibly with haptic feedback for the operator.

The driver is any suitable driver for the corresponding actuator. Drivers are well known in the art of electrical machines.

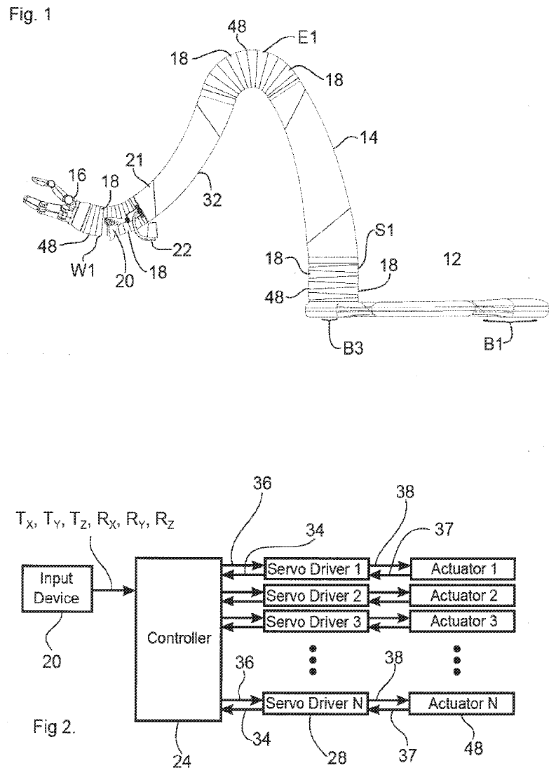

Referring to FIG. 1, there is shown a simplified view of a robot arm 10. The robot arm includes a Scara unit 12 having a fixed base B1, and an arm 14 secured to a mobile end B3 of the Scara unit 12 by a shoulder joint S1. Each joint S1, E1 and W1 comprises multiple wedges 18. The wedges 18 each comprise a portion of a robot arm and terminate at each end in a part of an actuator 48 symbolized by a line between wedges 18. Each actuator 48 comprises a part (rotor or stator) on one wedge 18 and another part (rotor or stator on an adjacent wedge, or other part of the robot arm.

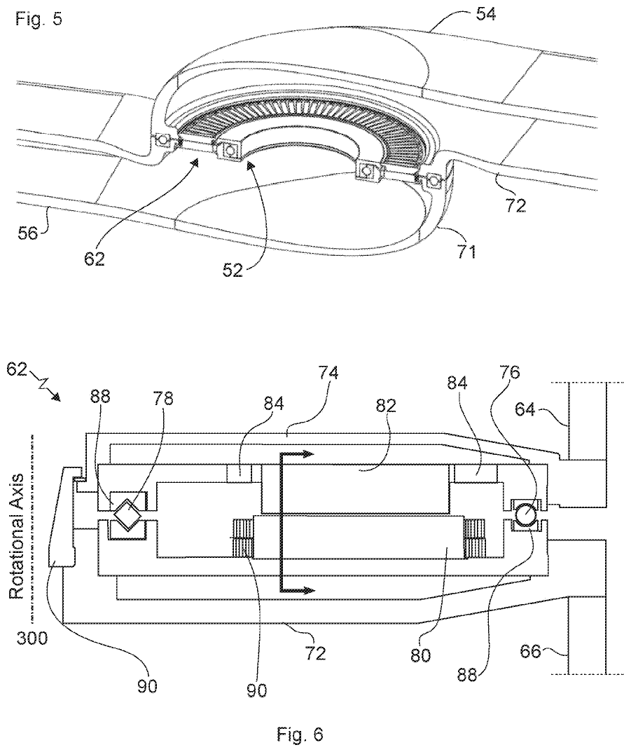

In this example, the arm 14 includes an elbow E1, a first wrist W1, and there may also be a second wrist at location 21, and an end effector 16. A hand control 20 may be located upstream of wrist W1 but downstream of location 21, and therefore downstream of a second wrist, if present. An arm control 22 may also be located with the hand control 20. The hand control 20 and arm control 22 may be used simultaneously by an operator to control the robot arm. When the hand control 20 is located between actuators, the actuators between the hand control 20 and the base B1 may be referred to as upstream actuators and the actuators between the hand control 20 and the end effector 16 may be referred to as downstream actuators. In an example, the upstream actuators may all be controlled by hand control 20 or arm control 22 operation to change the rotation speed of the upstream actuators (speed control), and the downstream actuators may all be controlled by hand control or arm control operation by angle to angle control. The Scara arm 12 may be replaced by a linear actuator or actuators or a telescoping arm. If a linear actuator is used, it may follow the design shown in FIG. 5 or FIG. 6, except with the device being linear rather than rotary.

In speed control, the degree of operation of the hand control 20 or arm control 22 causes the corresponding actuator to rotate at a speed that is proportional to the degree of operation. In angle control, the degree of operation of the hand control 20 or arm control 22 causes the corresponding actuator to move through an angle that is proportional to the degree of operation of the hand control. The operation of the hand control 20 or arm control 22 may comprise a displacement of the hand control 20, a force applied to the hand control 22, or a rotation of the hand control 20. The proportional relationship between the operation of the hand control 20 and the speed or angle of rotation of an actuator being controlled by the hand control 20 may be set by the user using controls on the controller 24. For the determination of proportional movements, a lookup table stored in the controller 24 may be used.

Referring to FIG. 2, there is shown a control diagram for the robot arm of FIG. 1. In practice, the hand control 20 may be mounted on the robot arm, for example between wrists, and produces control signals corresponding to a movement or force applied to the hand control. For example, translation along an x, y or z axis may produce translation control signals Tx, Ty and Tz, and rotation of the hand control about an x, y or z axis may produce rotation control signals Rx, Ry and Rz. In some applications, if only translation is required, then only translation signals are used. Correspondingly, where only rotation is required, only rotation signals are used. The control signals are provided along conventional communication channels denoted by the line 26 leading to controller 24. The communication channels may be wired, optical, wireless or any other suitable communication channel and may be entirely physically located within the hollow interior of a robot arm. An additional dial, button, lever or other control element such as a ring around the base of a hand control, may be used to provide an auxiliary signal which may be used to generate an auxiliary control signal for sending to the controller 24. There may be additional such control elements with corresponding additional auxiliary control signals. For example, an arm control 22 may also be secured to robot arm between wrists by a pivot or gimbal. The arm control 22 may pivot about an x axis and a y axis at the gimbal. The operator's arm may rest on the arm control 22 while the operator is also holding the hand control 20. Movement of the operator's elbow up or down may cause a pivot of the arm control about the y axis, while movement of the operator's elbow laterally may cause a pivot of the arm control about the x axis. Further auxiliary controls may be included, such as for example a device to send a control signal to the end effector 16 to open or close.

The controller 24 conditions and routes signals to the drivers 28, labelled drivers 1 through N, and any others that may be present with for example a one to one correspondence between the control signals and the drivers. In some instances, there may be a many to one correspondence between control signals and drivers, but the controller integrates (subtracts or adds) the many control signals to yield a single control signal to each driver.

The input to the controller 24 may be a multi-axis input device that the operator grasps. The following describes an embodiment where the input device has 6 axes, three translational (x,y,z) and three rotational (roll,pitch,yaw). In this embodiment, the input device may be a hand control 20 such as a 6-axis joystick. Other embodiments may have differing number of axes (eg. three translational plus one rotational). Input devices such as multi-axis joysticks are well known and commercially available. The input device may be mounted on the robot itself. The mounting location in this embodiment is near to the end effector, but upstream or behind the wrist W1.

When the operator deflects the input device, the robot joints upstream of the input device activate in a coordinated manner to move the end-effector with a velocity. The velocity is characterized by a magnitude (speed) and a direction of movement. The speed that is generated by the actuators increases in proportion to the magnitude of the deflection of the input device from its zero-position. The direction of the velocity generated by the actuators (more or less) corresponds to the direction that the input device is deflected relative to the mount of the input device.

When the user rotates the input device, the robot joints downstream of the input device may activate in a coordinated manner to orient the end-effector so that the orientation of the end-effector has a direct one-to-one or proportional angle relationship with the orientation of the input device. That is, an angle change of 1 degree of the handle will result in a 1 degree rotation about a parallel axis of the end effector when in 1 to 1 mode. If in proportional mode, as selected by the operator, the end effector will rotate by a greater degree or a lesser degree but will stop rotating when the handle stops rotating.

Since the base of the input device 20 moves with the robot (because it is attached to the robot) whereas the operator is standing on the ground, the deflection and rotation of the input device will change dynamically as the robot moves. Since the translation of robot is in the direction of the deflection of the input device, the motion of the robot will tend to cause the deflection of the input device to diminish, unless the operator moves the input device yet further in that direction. This essentially creates a feedback loop that will move the robot in any direction desired by the operator, and stop the robot when the input device is returned to its zero-positon.

The motion of the robot is related to the deflection and rotation of the input device as explained in the foregoing paragraphs. To effect that relationship, a control system converts the input device signals to electric currents that cause the actuators 48 to move.

The control system comprises controller 24. The controller 24 has inputs from the input device 20. These may be analog inputs or digital inputs, depending on the input device. The controller 24 has inputs 34 that read in the position and/or velocity of the actuators 48. In the embodiment shown, these inputs are from the servo drivers 28. In alternative embodiments (not shown) the inputs may come directly joint sensors mounted on the robot or on the actuators 48.

The controller 24 has internal logic. Based on the input from the actuator positions 34 the internal logic determines what the angles of the robot joints are at that moment. The internal logic then determines, based on the deflection and rotation of the input device and angle of the joints, what the desired actuator positions and velocities. The embodiment of the internal logic described herein may implement simple translation of the input device inputs into robot motions, such as the input causing equal and opposite motion of actuators. This embodiment provides for motion of the end effector in a direction that is nearly (but not exactly) in the same direction as the deflection of the input device. In alternative embodiments, the internal logic may comprise an algorithm based on inverse kinematics of the robot, in which case the motion of the end effector may follow more precisely the deflection of the input device. Internal logic of controllers is well known. For example, U.S. Pat. No. 6,140,787 provides one implementation of internal logic.

The controller 24 has outputs 36, one for each actuator 48. The outputs are signals that indicate the desired position and velocity for each actuator 48.

Servo drivers are well known and commercially available from many vendors (for example the Elmo Gold servo product line, commercially available from Elmo). The control system comprises a plurality of servo drivers 28, one for each actuator 48:

Each servo driver has an input 36 from the controller that sets the desired velocity and position of the actuator 48. Each servo driver has an input 37 from the actuator that indicates the actual actuator position.

Each servo driver has an output 34 that communicates the actual joint position and velocity to the controller 24. In general, while the robot is in motion the actual position and velocity of the joint will not be the same as the desired position and velocity.

Each servo driver 28 has a servo control circuit that uses a well known PID (position-integral-derivative) loop to generate an electrical current 38 to drive the actuator. In alternative embodiments, the servo driver 28 may comprise logic and software that implement other types of servo control algorithms. Design and implementation of servo drivers is well known, and many alternative embodiments are available to implement this component.

In alternative embodiments (not shown) the controller 24 is divided into several simpler controllers that each provide a subset of the functionality described in the foregoing, eg. one controller for the SCARA and another for the wedge actuators. In another embodiment (not shown) the function of the drivers 28 is incorporated into the controller itself and the output of the controller may directly activate the actuators 48. In another embodiment (not shown) the actuators may be stepper motors, in which case the feedback from the actuator to the servo driver may be eliminated. The architecture and design of alternative control systems is well known in the art, and there are many ways to implement the control system.

If the actuators 48 are rotary actuators they may all rotate in the same direction or alternating actuators may rotate oppositely, so a first actuator in a stack of wedges in a joint may rotate clockwise, then a second actuator may rotate counterclockwise, then a third actuator may rotate clockwise and so on. A first wedge (a section of the robot arm that is between two actuators that are at an angle to each other) and a last wedge in any array of four or more actuators that moves in unison are preferably half the angle of the rest of the wedges, in terms of the angle of their plane of rotation relative to an adjacent wedge, to prevent the robot arm 10 moving out of plane. When a pair of wedges counter rotate three actuators may need to move to prevent unwanted rotation of the robot arm 10.

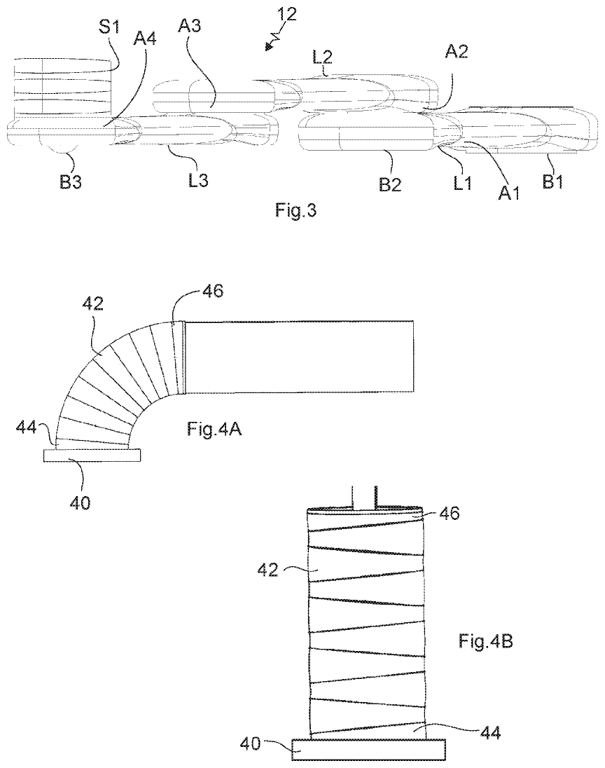

The actuators 48 may be driven proportionally to the magnitude of the control signals either in terms of speed control or angle control. Drivers 1-4 may be connected to drive the actuators A1 through A4 in the Scara 12 by speed control. As shown in FIG. 3, in the Scara 12, the actuator A1 is located above a structure contacting element or base B1 such as a pad that is connected via any suitable means to a surface of an object, for example a structure such as a floor, wall or ceiling, or the ground or a vehicle of any kind. A first link L1 is rotated by the actuator A1 about a vertical axis. At an opposite end of the first link L1 to the actuator A1, the actuator A2 connects to a second link L2 that rotates around a vertical axis of the actuator A2. The first link L1 may also be supported by the surface of the object through a pad or base element B2. Likewise the second link L2 is connected to a third link L3 by the actuator A3 and the third link L3 rotates relative to the second link L2 about the vertical axis of the actuator A3. There may be two or more links L1 etc in the Scara arm. In this instance, there are three links and the third link L3 connects to a shoulder S1 through the actuator A4. The shoulder S1 may rotate relative to the third link L3 about a vertical axis of the actuator A4. The third link L3 may also be supported on the surface of the object by base B3.

The base B1 may be fixed to the surface of an object, for example a floor. Base B2 and B3 may comprise a bearing element, for example as formed by a low friction surface, which could be a sliding surface or a surface of a rolling element such as a roller bearing. The axes of the actuators A1, A2, A3 etc are all parallel, which causes the links L1, L2, L3 to move in a plane perpendicular to the axes and the bearing element to move along the surface. Depending on the motion of the actuators A1, A2, A3 etc, the end of the Scara 12 may translate or rotate in an arc. For translation, the actuators A1, A2, A3 etc rotate alternately oppositely. The bases B2, B3 assist in supporting the robot. In general, link L1 forms a base link, and link L3 or one of a chain of links forms an end link. Links between the base link and the end link form intervening links. Adjacent links are connected by actuators having parallel axes. Motion of the actuators causes the links to move in a plane extending away from the base. The bearing element may be on the first link, the end link or one of the intervening links.

Drivers 28 may drive the actuators A1 through A3 or the actuators A1 through A4 to rotate in unison with the actuator A1 and the actuator A3 rotating one way, for example clockwise, and actuator A2 or actuator A2 and actuator A4 rotating the other way or counterclockwise. If the actuators A1 though A4 are stepper motors then the power commands may comprise power on for a set number of steps for each of the stepper motors in a given period of time. This causes the actuators A1 through A4 to rotate at the same speed. If it is desired that the speed of the stepper motors be different, so that they rotate different amounts in a given period of time, then each actuator may be a different size or have a different number of steps so that a given command to rotate a specific number steps results in a different rotation angle. The actuators A1 through A4 rotate so long as the hand control provides control signals through the controller 24 to the drivers 28. With electrical actuators, the time for the actuator to reach a speed set by the position of the hand control 20 is normally so short in relation to the time it takes for an operator to move the hand control 20 that the speed response is essentially instantaneous. The operator may not notice the acceleration.

The hand control 20 may be provided with a spring (not shown, but common in 3D controllers) that returns the hand control to neutral (no outgoing control signals). When the hand control 20 returns to neutral, all actuators stop. An example of the hand control 20 may be formed of a normally vertical tube that rotates and translates relative to a ball at the center of the vertical tube with springs on all axes including translation axes.

When the hand control 20 is translated or a force is provided in the y direction, the drivers 28 may provide a different set of speed control power commands to the actuators A1 through A4 so that the actuators A1 through A4 rotate either more clockwise or counterclockwise so that the actuator A4 at the end of the Scara 12 tends to move right or left relative to a point of view looking out from the base B1 of the Scara 12 outward along the Scara 12. For each of the shoulder S1, an elbow E1, and the wrist W1 or wrist W2, there may be any number of actuators, for example four to ten, but could be more.

When the hand control 20 is translated or a force applied in the z direction (vertical), the hand control generates z translation control signals through the controller 24 to the drivers 28 which send drive signals to the shoulder joint S1 or the elbow joint E1, if present, and the wrist joint W1. Each of the shoulder joint S1, or the elbow joint E1 if present, and the wrist joint W1 have one of the actuators or one of the sets of actuators, the effect of which is to cause rotation about a horizontal axis and therefore lift or lower the end effector end 16 of the robot arm A in the z plane. Shoulder joint S1 or elbow joint E1 may comprise a single actuator with a horizontal axis or may be formed of multiple actuators.

In the case where the shoulder joint S1 comprises multiple actuators, the actuators may be at an angle to each other. The angle may be for example non-zero and less than forty-five degrees (45°). Each link between the actuators 48 in the joint S1 therefore becomes a wedge joint with a short side and a long side. When the actuators are rotated so that all the short sides are on the same side, the robot arm 10 is bent concave in the direction of the short sides. By rotating all the actuators 48 up to 180° in unison with alternating actuators 48 rotating in opposite directions, the shoulder joint S1 goes through a point where all the actuators 48 have rotated 90° and the joint is vertical, to a point where the actuators 48 have all rotated up to 180°. The effect of this rotation is to raise or lower the effector end 16 of the robot arm 10 relative to the first actuator in the shoulder joint S1 (or the actuator A4 in the Scara 12) depending on the degree of movement or applied force of the hand control in the z direction. The first wedge and last wedge in any array of four or more actuators that moves in unison may be half the angle of the rest of the wedges to prevent arm moving out of plane.

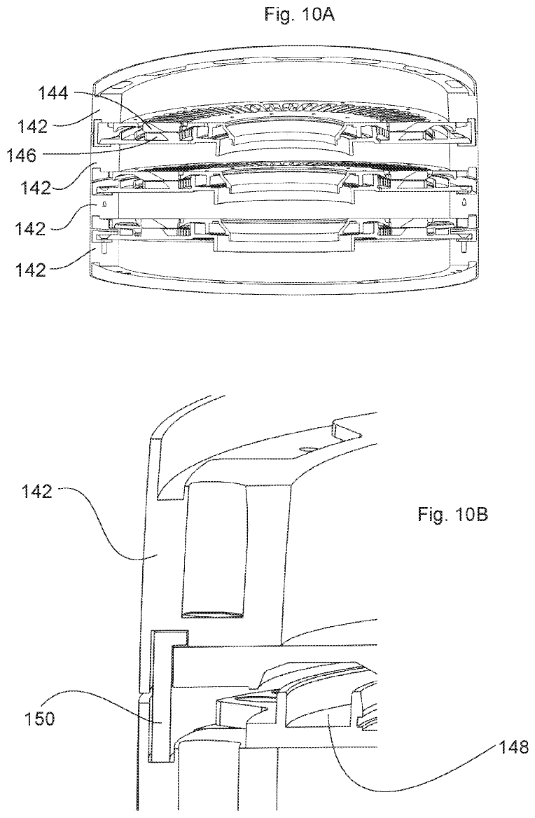

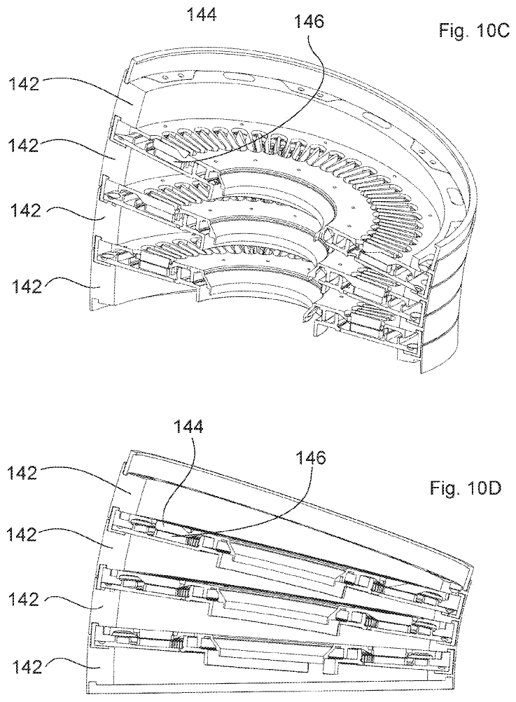

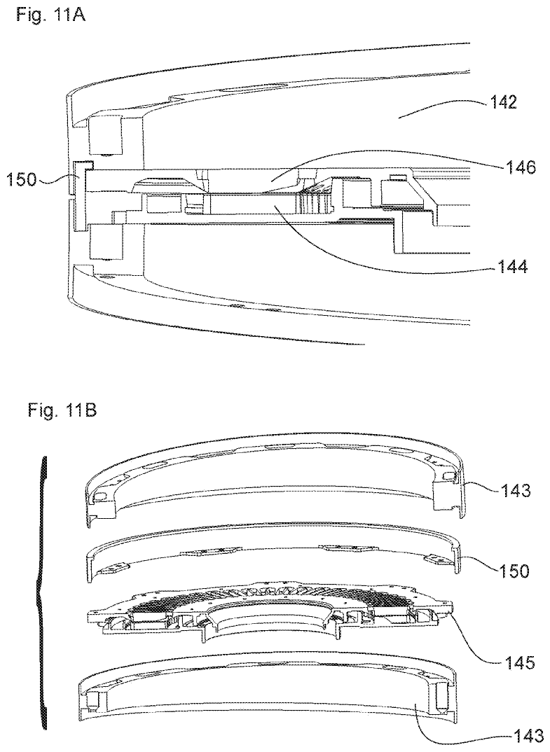

For example, there is shown in FIG. 4A and FIG. 4B a portion (wedge bot) of a robot arm with a base plate 40 and being formed in this instance of ten wedges 42. To keep the robot arm in plane, the bottom wedge 44 and top wedge 46 need to be half the angle of the other wedges. In the example shown, ten wedges are used at 10° each. The first and last wedge are 5°. Each wedge 42, 44 and 46 may be formed as shown in FIGS. 10A, 10B, 11A and 11B.

If the top wedge and bottom wedge are not half angle, the robot arm 10 stands skewed. The following table shows the direction of rotation and the angle of rotation for each wedge for an example operation of a robot arm.

| Wedge/Motor | Direction | Rotation Angle (deg) |
|---|---|---|
| Base (Half Angle) | CCW | 90 |
| 2 | CW | 180 |
| 3 | CCW | 180 |
| 4 | CW | 180 |
| 5 | CCW | 180 |
| 6 | CW | 180 |
| 7 | CCW | 180 |
| 8 | CW | 180 |
| 9 | CCW | 180 |
| 10 | CW | 180 |
| Arm | CCW | 90 |

In FIG. 4A, the thin end of the wedges 42 are all aligned so that the wedge stack is maximally bent in one direction. The first and last wedges have half the wedge angle of the intermediate wedges. If all wedges 42 are rotated 180 degrees, alternating wedges oppositely, the wedge stack goes through an intermediate position shown in FIG. 4B where all wedges 42 have rotated oppositely pairwise 90 degrees (each odd rotates clockwise for example, and each even wedge rotates counter clockwise for example) and the stack is vertical, to a position where all wedges 42 have rotated 180 degrees and the thin ends of the wedges are oriented oppositely to the position shown in FIG. 4B so that the stack bends maximally in the opposite direction.

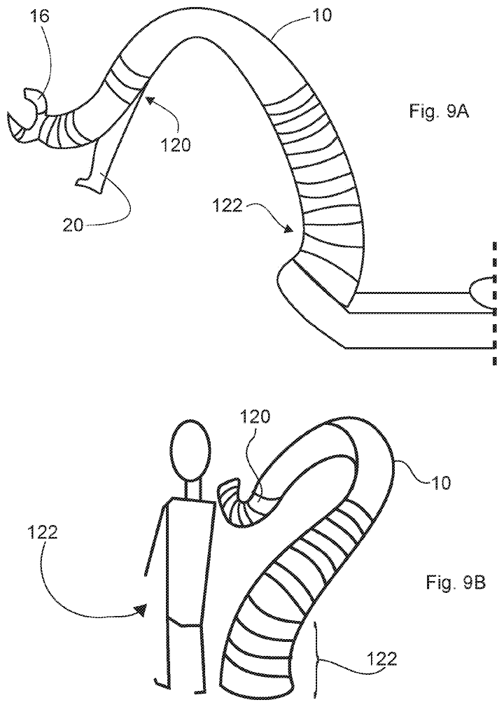

If each of the actuators in a joint is at a low angle, for example one degree relative to an adjacent actuator, then when the actuator rotates 180°, the actuator only lifts the robot arm a little, thus providing a mechanical advantage. The more actuators, the lower the angle, then the greater the mechanical advantage. This advantage applies with best effect when the robot arm is located in the plane defined by the aligned shortest sides (0° point) and aligned longest sides (180° point). The greater the deviation of robot the arm from this plane, the greater the loss of mechanical advantage. Additional hand adjustable wedge joints 120, 122 may be provided in the robot arm, for example next to any of the sets of actuators, the elbow E1 or the wrist, on both sides, to allow the operator to manually locate the robot arm as shown in FIGS. 9A and 9B without using the electric actuators at an inefficient angle.

The elbow E1 may be controlled in like manner to the shoulder S1 by the driver 28 with all of the actuators 48 in the elbow E1 rotating in unison up to 180° to effect a lifting action in response to a power command from the controller 24. The actuators 48 in the elbow E1 may alternate in rotation directions. The degree of rotation controls the amount of lifting or lowering. The first wedge and last wedge in any array of four or more actuators that moves in unison must be half the angle of the rest of the wedges to prevent the robot arm moving out of plane.

The wrist W1 may be controlled in like manner to the shoulder S1 with all of the actuators 48 rotating in unison up to 180° to effect a lifting action in response to power commands from the controller 24. The actuators 48 in the elbow 28 may alternate in rotation directions. The degree of rotation controls the amount of lifting or lowering. There may be any number of actuators in the wrist W1. In an embodiment, the hand control 20 is located between the wrist W1 and a second wrist joint.

For rotation control about the x, y or z axis, angle to angle control may be used. In angle to angle control, a rotation of the hand control 20 generates a rotation control signal that is proportional to the angle rotated by the hand control 20. For each of axes x, y and z, this signal is provided to the controller 24, which routes and conditions control signals for the drivers 28. One of the drivers 28 may respond to an x axis rotation of the hand control 20 (twist hand like turning key in lock) and send a power command to a horizontal axis actuator on the end of the wrist W1, which causes an angle to angle rotation about a horizontal axis of the robot arm at the end of the wrist W1 and therefore the end effector 16. The controller 24 may respond to y axis control signals (motorcycle throttle motion) to send angle to angle drive signals to the actuators 48 of the wrist W1 to effect an effective rotation of the wrist W1 about a horizontal side to side axis. This motion tends to lift and raise the end effector 16 as well. This y axis angle rotation command may cause each second actuator in wrist W1 to rotate in the same direction, but each other actuator 48 to rotate in opposite directions by the same amount. Having the rotation by the same amount causes the actuators 48 and the payload to remain on plane and reduces torque on the actuators.

If the operator uses the hand control 20 and by so doing maintains the robot arm 10 at the hand control 20 vertical, then a first downstream actuator from the hand control at wrist W1 may be used to rotate the end effector around a vertical axis.

For rotation of the end effector about the x axis, a horizontally oriented actuator 48 may be driven by a respective driver 28 to rotate a specific angle. For rotation about the z axis, a vertically oriented actuator 48 may be driven to rotate about a specific angle. For rotation about the y axis, multiple actuators 48 of the wrist W1 may be caused to rotate in unison up to 180°.

For improved dexterity and lifting capacity, the shoulder S1 may move about a horizontal axis as shown in FIG. 1 (in this figure, horizontal corresponds to a line through the center of the actuator stack that extends perpendicularly to the page). That is, the actuators in S1 may rotate in unison 180° alternating clockwise and counterclockwise, to cause an effective rotation of the arm about a horizontal axis and therefore a lifting of the robot arm. The first wedge and last wedge in any array of four or more actuators that moves in unison must be half the angle of the rest of the wedges to prevent the robot arm moving out of plane. For improved dexterity and lifting capacity, the elbow E1 may move about a horizontal axis as shown in FIG. 1 (in this figure, horizontal corresponds to a line through the center of the actuator stack that extends perpendicularly to the page). That is, the actuators in the elbow E1 may rotate in unison 180° alternating clockwise and counterclockwise, to cause an effective rotation of the arm about a horizontal axis and therefore a lifting of the robot arm. The robot arm at the hand control may be maintained vertical at all times to reduce operational complexity. The wrist W1 may move proportionally to the elbow E1 and the shoulder S1 so the axis of an actuator 48 at the wrist W1 will remain near vertical.

A user forearm attachment 22 can be used to control the angle of the forearm 32 about a vertical, z axis, and horizontal y (motorbike throttle) axis. This may be an angle displacement=angle speed response where a sideways angle of the forearm rest 22 (about a vertical axis) will result in the shoulder vertical axis rotating in one direction (and preferably that one or more other Scara axis rotate in opposite directions) so the non-Scara arm rotates around the user to achieve a different angle (about a vertical axis) of approach to the payload.

Rotation of the user-forearm rest 22 about a throttle axis may result in the elbow E1 and shoulder S1 rotating about a horizontal axis, but in opposite directions so the robot forearm (the arm between the elbow E1 and wrist W1) can be controlled by the operator to be more vertical or more horizontal. In this way, the angle of the robot forearm will follow the angle of the operator's forearm. The wrist W1 angle will be doing its job as stated above, of keeping the top of the wrist in a vertical axis attitude.

One way to control stacked actuators, where the actuators in the robot arm are separate by wedges, as for example as shown for the shoulder S1, the elbow E1 and the wrist W1, is as follows. The respective axes of consecutive actuators may be offset relative to each other by a few degrees such as 1° to 10°, 10° to 20°, or 20° to 30°. Thus the wedges turn angles of like amount. Actuators are operated in pairs. The pairs may comprise consecutive actuators or they may be separated. The initial position of the actuators may be taken as the zero position, where all shortest sides of the wedges are aligned as shown in FIG. 4A. Degree of rotation is measured from the zero position. Rotation of 180° corresponds to a half rotation of any one of the actuators. If all of the actuators rotate 180°, then all of the actuators will be aligned with the shortest sides of the wedges aligned at 180°. The actuators have the greatest mechanical advantage when they rotate near 0° or 180°, for example 0° to 20°, referred to as initial rotation or 160° or 180°, referred to as final rotation.

To effect a lifting movement, all of the actuators in a joint may initially be 0° for example as shown in FIG. 4A. In this process, all pairs are moved with actuators of the pair rotating in opposite directions. All of the actuators may be rotated through an initial rotation to a position I with actuators of any pair rotating oppositely so that the robot arm remains approximately on plane. The actuators are then rotated one or a few pairs at a time from the position I to a position F, corresponding to where the final rotation starts. During the rotation of one or a few pairs at a time from I to F, the remaining actuators rotate back to zero or close to zero degrees. The remaining actuators then rotate pairwise back to position I. This process (one or more pairs of actuators are taken from I to F while the remaining that have not gone from I to F go to zero or close to zero, and then the remaining pairs are rotated back to position I) may be repeated until all actuators are at the position F, then all actuators may be rotated pairwise from position F to or near to one-hundred eighty degrees.

FIG. 5 shows an exemplary axial flux actuator 52 in a configuration useful for use in a Scara configuration in particular, where the actuator 52 has an axis perpendicular to the arms 54 and 56. The arms 54 and 56 may be any of the arms of a robot arm in some embodiments. In an embodiment of a joint that has an actuator with a rotation axis perpendicular to the robot arm, one or more actuators 52 may be used that are coaxial to each other. Depending on the embodiment, the actuator 52 may be used for any of the disclosed Scara, shoulder, elbow or wrist joints. In particular, in a mode of operation of the robot arm such that the hand control operates to control upstream actuators differently than downstream actuators, for example when upstream actuators are controlled using position of hand control to velocity of actuator control and downstream actuators are controlled using position of hand control to angle of actuator control, the actuators being controlled may have the configuration of FIG. 5.

FIG. 5 shows more detail of an exemplary design of an axial flux actuator 62 that may be used for any of the actuators in the robot arm, including the axial flux actuator 52. In FIG. 6B, two arm members or links 64 and 66 are connected by the axial flux motor 62. The arm members or links 64, 66 may be part of any of the wedges or other parts of the robot arm 10 or part of the links in the Scara 12. Actuator 62 may have a stator 72 attached to the link or arm 66 such as with bolts and/or adhesive and/or thermal fit or by being formed integrally with the arm. A rotor 74 is attached to a link or arm 64 such as with bolts and/or adhesive and/or thermal fit or by being formed integrally with the arm. An outer bearing 76 and an inner bearing 78 allow relative rotation of the stator 72 and rotor 74 and provide precise relative axial location of the stator 72 and rotor 74 to maintain an airgap of a desired gap between the stator posts 80 and rotor posts that hold magnets 82 and that provide a flux path for the magnetic fields provided by the magnets 82. The rotor 74 may have flux restriction holes 84. The use of the inner bearing 78 inside the inner diameter of the airgap and the outer bearing 76 outside the outer diameter of the airgap distributes the attractive forces between the stator 72 and rotor 74 between two bearings for longer service life and/or lighter bearings. The use of inner diameter bearings 78 and outer diameter bearings 76 also reduces the mechanical stress on the stator 72 and rotor 74 to allow a thinner cross section and lighter weight, for example as is possible with the high pole count of embodiments of the device.

The axial magnetic attraction between the stator 72 and rotor 74 which results from the permanent magnet flux in the rotor 74 provides axial preload on the bearings 76, 78. It has been shown by analysis and experimentation that with high strength magnets such as but not limited to neodymium N52 magnets, this axial force is adequate to keep the bearings 76, 78 preloaded in the stator 72 and rotor 74 and to provide adequate axial force to allow the links 64, 66 to support useful loads in all directions. This load may be a combination of the arm weight and acceleration forces and payload in any direction. The use of the magnetic forces to provide the bearing seating force and axial preload on the bearings allows for the use of thrust load and/or angular contact bearings which can be preloaded by the magnetic attraction of the stator and rotor to remove bearing play in the axial direction. By using a combination of bearings that are radially and axially locating, it is possible to preload the bearings with magnetic force, in radial and axial directions and to eliminate the need for additional mechanical retention of bearing races 88 to prevent movement of the races in the opposite direction of the magnetic force. This preload eliminates bearing play and increases bearing rigidity such that the assembly becomes very precise in its movement. This has advantages for precision applications such as robotics. It also has the advantage of reducing the inconsistent cogging effect that could result from radial displacement of the rotor. This is especially important when the device has a high number of very small cogging steps such as with embodiments of the device.

Windings 90 in actuator 62 may be of any suitable design. A number of stator posts 80 and rotor poles (magnets) 82 may be used to provide a desired number of cogging steps. For example, if there are 96 stator posts 80 and 92 rotor poles 82, then over 2000 cogging steps may be provided (least common multiple of 96 and 92. In addition, it is desirable to evenly distribute load on the bearings 76, 78 and this can be provided by having four or more regions of peak magnetic attraction, such as is provided by using 96 stator posts 2410 and 92 rotor poles 2310. The number of regions of peak magnetic attraction is the greatest common divisor of 96 and 92, namely four in this instance.

A non-limiting example of axially preloaded races with no need for mechanical retention of the races 88 on the bearings 76, 78 is shown in FIG. 6 where the inner roller bearing 78 (in this non-limiting example, a cross roller bearing) is sandwiched between two bearing grooves such that the axial magnetic attraction between the stator 72 and rotor 74 eliminates axial and radial play in the bearing 78. The bearing 78 is, in this non-limiting exemplary embodiment, a cross roller bearing with axial and radial locating stiffness. As a result, the axial preloading of the rotor and stator provided by the magnets 82 in the rotor 74 results in a precise relative location of the stator 72 and rotor 74 in the axial and radial directions. This precise location is accomplished without the need for mechanical or adhesive bearing race retention in the opposite axial direction of the magnetic attraction force between the stator and rotor. A counterbearing 90 may be used to prevent unwanted separation of the rotor 74 and stator 72 under load. The counterbearing 90 is fixed to one of the stator and rotor and overlaps a part of one of the other and the overlap may form a bearing for example with use of bushings at the contact between moving parts.

Examples of Control Motions:

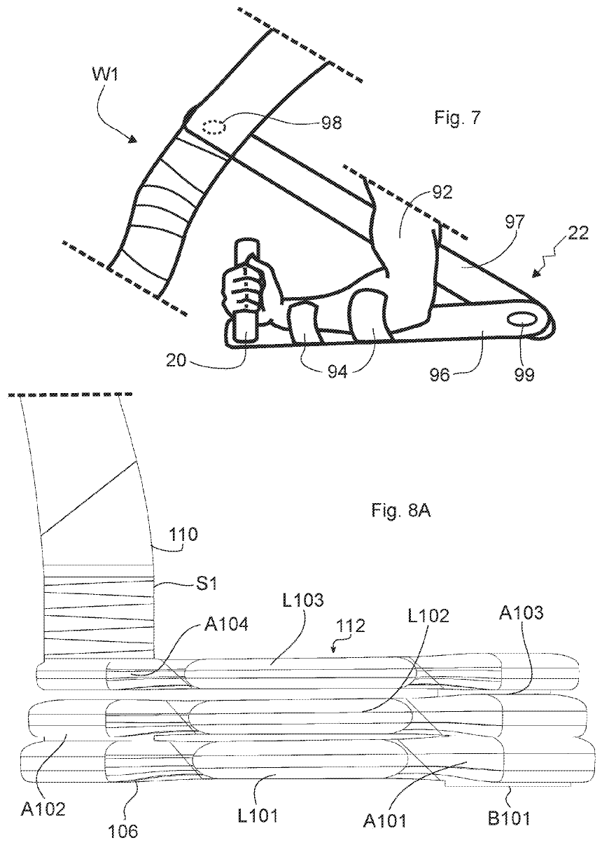

These movements are described relative to FIG. 1, FIG. 2 and FIG. 7. FIG. 7 shows a detail of an example of the arm control 22 of FIG. 2. The operator's arm 92 rests in curved arm rests 94. The arm rests 94 are attached to a lever 96 that attaches to the robot arm between the wrist W1 and the wrist W2 at the gimbal 98. Movement of the arm 92 and consequently the elbow of the arm 92 up or down causes a rotation about the gimbal 98 around a horizontal axis (motor cycle throttle) and movement of the arm 92 sideways (left or right relative to the user) causes a rotation of the lever 97 relative to the gimbal 98 about a vertical x axis. A compensatory rotation of the lever 97 relative to the lever 96 about pivot or gimbal 99 also occurs. Control signals are sent from the gimbal 98 to the controller 24 of FIG. 1 to drive corresponding actuators. For example, move the arm 92 to right, the actuator A4 goes counterclockwise (cc), the actuator A1 rotates clockwise (cw). The hand control 20 need not move during the movement since the operation can compensate with movement of the operator's wrist. Thus if the operator moves the arm 92 side to side, this causes a movement clockwise about the gimbal 98, the actuator A4 moves counterclockwise under angle to speed control, with actuator A1 moving clockwise, actuator A2 moving counterclockwise, and actuator A3 moving clockwise, in proportion as provided by a lookup table in the controller 24. The actuators move so that the hand control 20 does not move. The overall effect is that the robot arm follows what the arm 92 is doing. So a movement of the elbow arm to the right causes the Scara to rotate to the right and draw the forearm of the robot arm around to the right. To do this motion, the controller 24 needs to do some computation. The controller 24 needs to know angle of the actuator A4 relative to a radius from the base B1 of the Scara, and likewise needs knowledge of all arms and the angle information may be provided by an encoder or by storing the stepper motor control signals. The end result is approximate alignment of hand input with upper arm plane at all times. Movement of human elbow 92 up and down rotates a forearm gimbal 99 on horizontal axis, the elbow E1 extends, makes the forearm between W1 and E1 go horizontal or tilt, the shoulder S1 extends, the Scara retracts, the elbow E1 goes down, and actuators A1-A2-A3-A4 rotate so that the Scara retracts.

If one of the controls such as the forearm control of FIG. 7 provides signals to drive an actuator through the controller 24 that is also provided signals by another control such as a hand control 20, the controller 24 sums the control signals. The same applies when a single control such as the hand control 20 provides two different control signals to the same actuator. Thus, a translation sideways (normal y axis control) of hand control 20 can causes different commands, as for example x axis control. Thus, for example, if the hand is moved at 45° to the forward direction, this can cause equal x, y axis movement. The control inputs add or subtract, and need not be very precise due to reaction input from the hand control 20 and forearm.

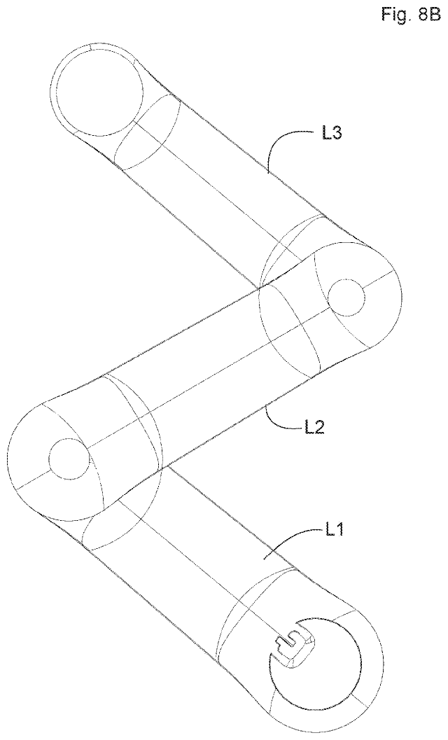

As shown in FIG. 8A, Scara base 112 may be fixed to a surface by vacuum suction or any suitable fastener arrangement, and may comprise links L101, L102 and L103 connected by actuators A101, A102, A103 and A104. The robot arm 110 may be designed as shown in FIG. 1, and the base of the shoulder S1 may be oriented at an angle to vertical, for example tilting backward (towards the right in the figure) 10 degrees to 30 degrees. The first link L101 may comprise a base B101 for securing the Scara base 112 to the surface of an object and a bearing element 106 for rolling or sliding on the surface. The bearing element 106 may comprise a low friction surface or rolling element such as a ball bearing.

All actuators disclosed in this document may be axial flux motors having the hollow design shown in FIG. 5 or FIG. 6, although other actuators for example disclosed in WIPO publication WO2017024409 published Feb. 16, 2017, may be used. Wires and other components for sending power and control signals, or cooling fluid, if present, may pass through the hollow actuators. Each axial flux motor comprises a stator and rotor. The order of the stator and rotor in any implementation of a motor or actuator is not relevant. In a design of the actuator, the selection of the height of the posts, number of posts and pole density may follow the description in WIPO publication WO2017024409 published Feb. 16, 2017. There may be many short posts and many poles. The number of poles and posts may be determined based on the size and torque requirements of the intended application.

FIG. 8A and FIG. 8B show two embodiments of a Scara. In FIG. 8A, each link L102, L103 of the Scara rests above a previous link, so that the links are stacked in the axial direction of the actuators. In FIG. 8B, the first link L1 and third link L3 underlie the second link L2 of the Scara. Various Scara designs may be used.

The signals from the hand control 20 received by the controller 24 may be translation control signals or rotation control signals. Everything upstream of the hand control 20 may be position to speed control. All the downstream actuators may be controlled by angle control. An upstream actuator may be controlled in unison with a rotation of the end effector 16. An x-y displacement may causes radially outward movement away from selected point. If shoulder S1, elbow E1 and wrist W1 are present, then a vertical displacement of the hand control 20 causes elbow speed rotation to move hand control 20 in arc outward along a radius, and rotation of shoulder S1 causes upper arm (between shoulder S1 and elbow E1) to move upward. Movements may be scaled so that a vertical displacement of the hand control, for example 1 mm, may cause elbow to move 10% up and radially outward. Use of a hand control 20 and the control system allows reactive movements by the operator to compensate for movements of the robot arm. This happens because the hand control 20 resists movement as the arm translates, so that the operator pulls back on hand control 20. The operator can always be adjusting to the movement of the arm as carried through to where the hand control is on the arm.

The controller 24 may be made up of one or more controllers. A single device is shown for convenience. The number of steps that cause a given amount of speed or rotation angle may be varied. For example, if an elbow E1 is present, a vertical displacement of the hand control 20 increases elbow angle. The hand control 20 then moves forward on an arc created by movement of the arm at the elbow E1, creating a relative displacement towards the base and the Scara and shoulder S1 retract to result in generally vertical motion of the hand control 20. For another example, if there is a shoulder S1 and no actuated elbow E1, then vertical translation of the hand control 20 results in a rotational speed command to shoulder S1, and a horizontal translation does not cause shoulder to rotate. Additional controls may be provided for damping, acceleration rate and deceleration rate, speed control and safety stops. A separate control such as a dial under a hand control may provide signals to control the actuator A4, or otherwise rotate a shoulder S1.

A vertical axis actuator at the wrist may be operated independently of other actuators in the wrist. This actuator may work with shoulder rotation by actuator A4 or start with a delay and be proportional, both could be user set. The end effector 16 may be operated in plane with the robot arm, and particularly in plane with the wrist W1 and elbow E1. Depending on the amount of payload, there may be some out of plane bending. A current sensor at the corresponding driver may be used, or a multidimensional load cell between end effector 16 and wrist W1. Feedback from the current sensor or load cell may be compared with a threshold or standard based on known energy consumption for the actuators when loaded off plane and the length of time the end effector 16 is off plane may be limited. The higher the load, the lower the out of plane angle permitted for a given time. For a shorter time of off plane load, a higher off plane load may be permitted.

The actuator A4 may be also operated in angle to angle mode. If there is an actuated elbow E1, the shoulder S1 may rotate about a vertical axis proportionally to Scara axes to accommodate rotation of the last Scara link. The shoulder S1, when the Scara is actuated, may translate approximately along a radius. All first five of the actuators A1 through A5 may rotate together. However, if no elbow is present, then the shoulder S1 may be actuated independently to the Scara actuators. As actuators of the shoulder S1 rotate, this changes z height of the end effector 16. If shoulder S1, elbow E1 and wrist W1 and/or W2 are present then a vertical displacement causes elbow speed rotation to move hand control 20 in arc outward along a radius, and shoulder S1 rotation causes upper arm to move upward. This displaces hand control 20 upward and/or forward and natural action is for operator to counter resistance provided by springs on hand control 20 so that operator pulls back on hand control.

As shown in FIG. 9A and FIG. 9B, there may be manually actuated joints 120, 122 before and after the actuator stacks at the shoulder, elbow or wrist of a robot arm 10. In proportional rotation, subsequent actuators in a stack match a predetermined angle to the first actuator, for example three Scara actuators and one shoulder actuator may match the rotation angle of a first Scara actuator. To control the angle, each of the actuators for example the first four actuators are different sizes with different pole counts or different step counts. Whatever step per second is required of first actuator A1, then send same number of steps to other actuators A2-A5 in series. Different sizes or pole counts of the actuators A2-A5 will then effect a different amount of rotation or rotation speed. In instead, different step numbers are used, different motor controllers are needed. The operator can walk with hand control 20 forward and adjust to how much arm extending.

The following operational control layers may be present.

Layer C1 is the proportional angular rotation of the Scara actuators A1-A4. Layer C2a is the operator can adjust for non-linearity of motion at end of Scara arm, so that if the robot lags behind, the operator pushes more. Layer C2b is that the speed response changes depending on the angle of the first actuator, for example actuator A1 in the Scara. As the robot arm is extended, the same displacement of the hand control 20 results in greater rotation speed of actuators. The feedback loop is human operated and learnable. Layer C3 is side to side translation when operator moves hand control 20 right or left. Displacement distance controls the speed of either just the base actuator A1 or four Scara vertical axis actuators. Operation of this layer may use a look up table in the controller 24 to condition the signals to the drivers. For example, for a fully extended Scara, actuator A1 might rotate 20°, actuator A2 might rotate negative 30° actuator A3 might rotate 40°, and actuator A4 programmed up to some number of degrees depending on the amount the hand control 20 is pushed left or right. This process may use preprogrammed proportionality, with the proportion values stored in a lookup table in the controller 24. For layers C1 through C3, the hand control may be remote.

In layer C4, a vertical motion, the operator lifts the hand control 20 straight up, elbow E1 extends by use of multiple wedge actuators rotating oppositely or by use of an actuator with a horizontal axis. As the elbow E1 extends, the hand control naturally is pulled backward, which causes Scara arm to retract slightly. The hand control 20 may be rigidly fixed to the robot arm or attached through a spring. The controller 24 may need to know what angle the hand control is at relative to the robot arm to identify what vertical motion is possible, for example by using a sensor. In layer C5, the wrist W1 is controlled by angular displacement or rotation about its own axis of the hand control 20. A movement of the hand control 20 (for example, without a spring) may cause a proportional angular displacement of end effector 16. The end effector 16 may point straight out, then if the hand control 20 rotates left, the end effector goes left, same amount at same speed, using for example a stepper motor forming an actuator that is the closest actuator to the end effector of the stack of actuators forming the wrist W1. The angle movement of the hand control 20 may be proportional to angle movement of wrist W1 and could be adjustable so N degrees of rotation of hand control 20 corresponds to KN degrees of movement of end effector 16. K is a factor that could be preset or adjusted on the fly. K may be stored in the controller 24.

Layer C6 is an override. An override might occur due to a sudden change in direction, angle rotation or speed of the hand control or forearm control, or sudden change of payload displacement, angle rotation or speed. If an override condition occurs, an interrupt may be sent by the controller to stop all signals from the drivers reaching the actuators. In addition, if the operation lets go of hand control, the system may go to interrupt. If vibration of the load is too high, this may be detected by a load sensor on the end effector 16 and all actuators stopped until vibration goes below a preset level.

In Layer C7, the proportion of hand control 20 rotation to wrist rotation may be preset or set by operator button. For example, rotate hand control 45°, wrist rotates say 22.5°, and actuator A4 also rotates 22.5°. The controller 24 may do some computations to rotate A1, A2 and A3 to avoid translation at wrist, which can be done by standard reverse kinematics.

The shoulder S1 may be a horizontal axis actuator or stack of rotary wedges, and operated as with each of the disclosed stacks. The shoulder S1 causes a vertical motion of the robot arm. At end positions of the shoulder S1, more rotation steps of the actuators in the stack are needed to achieve a given vertical motion as when the shoulder is at a 90° position. At an initial position, the shoulder S1 is fully retracted, all of the actuators at 180°, with thin end of each wedge pointing back towards the base of the Scara 12. When all actuators are at zero degrees 0°, all thin edges are in the opposite direction, fully extended. At 90°, the shoulder S1 is half extended. So long as each actuator rotates equal amounts in opposite directions, the arm never goes off plane. For force multiplication arrangement due to the angle of the actuator axis relative to an adjacent actuator, the actuators may be thin, for example sixteen millimetres (16 mm). If actuators rotate differently, the arm goes off axis. This is good for dexterity, but loses mechanical advantage of the wedges in the joints.

In layer C9, the wrist W1 is provided along with a second wrist. This allows rotation of the end effector 16 by rotating only a vertical axis actuator. The wrist W1 can be used to keep the wedges of a second wrist in plane to avoid excessive power consumption. To keep an actuator vertical, a computer computation might be needed based on the number of steps rotated by each actuator for a given position. This computation is sufficient to keep the actuator vertical. An additional set of forearm actuators may be provided to fix the robot arm. Fixable actuators 120, 122 like those shown in FIGS. 9A and 9B may be rotated on a bearing, set with a brake and locked in preferred position. Manual actuators may be user adjustable, and may be used for example to rotate the robot arm off axis so the wrist remains on axis. Manual actuators may be used anywhere in the robot arm. In FIGS. 9A and 9B, the manual actuators 120, 122 are located at the upper part of the wrist W1 or the bottom of the shoulder S1 closest to the Scara. A manual actuator may also be provided at the wrist W2 before the end effector 16. The end effector may also be replaced by a quick detach bracket, which may be located at the end of a series of fixed joints between the bracket and wrist W2.

The elbow E1 and shoulder S1 can operate with any joints, not just wedges, in some embodiments.

If it is desired to keep the wrist array formed of W1 in plane, for maximum lift, twisting the hand control 20 from side to side may rotate the shoulder (which is behind the operator) in rotation angle to proportional rotation angle mode. This maintains the ideal in-plane alignment of the shoulder, elbow and wrist. The upstream Scara joints can, optionally but preferably be commanded to counter rotate so the additional input from the hand control are minimized. Optionally, because there is some ability to go out of plane with the joints, the wrist could bend to the side slightly when the hand control is rotated about a vertical axis with the shoulder rotating in unison. In some applications, a servo mode may be provided.

A force transducer may be provided at the end effector 16. When an operator is about to move a payload, the operator may stop all motion and zero the force transducer. If the sensor feels contact of the end effector with a body, the controller 24 may be configured to change the sensitivity of the relationship of the amount of translation to the speed of the actuators. For example, if in an initial state 1 mm corresponds to X speed, the the sensitivity may be changed to 5 mm to X speed. This modification of sensitivity may be applied to all drivers and actuators, and all drivers and actuators may be shut down if the sensor feels contact above a given limit.

Fixed wedges 120, 122 in FIGS. 9A and 9B may be used above and below the wrist and the shoulder. The advantage of such wedges is to lower power consumption, especially with a high payload. For increased payload, wedges may be adjusted so that repetitive operation with high load is done primarily near rotational limit of shoulder, wrist or elbow, with the actuators at near 0° or 180° to provide the greatest mechanical advantage. Manual wedges 120, 122 may also be used to change side to side angle of the bottom actuator and the top actuator of any joint, which aids in increasing dexterity and clearance between the robot arm and the operator. There may be multiple dials or manually operated wedges, each one rotating the vertical axis of shoulder S1 separately. The manual operation of one of the shoulder joint manually operated wedges may be opposite to the rotation of the Scara 12.

A wrist motion of the operator about the x axis, which corresponds to twisting about the axis of the forearm may rotate the last actuator in wrist array W2. The load cell could be before or after the last actuator. Angle to angle operation for the actuators for the wrist W2 may be limited to operator limit of motion, with a change in mode of operation of the robot in a given range of movement. If the operator is in a space with a 90° limit on any axis, for example with objects near the operator, then the controller 24 may be configured so that when the wrist has rotated a given amount, for example 80°, a further change in angle of the hand control 20 causes a speed response in the actuators. The region in which the change in mode of control occurs may be set by the operator, for example from 10° to 20°. In a stowing mode of operation, the operator may move the hand control to make the end effector 16 to move in a direction, then if the operator releases the hand control, the controller may be provided with a signal from the hand control indicating the release of the hand and then send a signal to slow all actuators.

An exemplary design of the wedge joints that may be used for any of the joints S1, E1, W1 or W2 is shown in FIGS. 10A and 10B. The more wedges, the lower wedge angle and more mechanical advantage. Mechanical advantage results from ten actuators rotating 180° with resulting output of only 90° or 45°. The torque on individual actuators may be kept relatively low. For example, if the robot is lifting 150 lbs, the torque on each actuator may be one half of passive cooling power.

In general, the operator may apply translational or rotation force that controls movement of entire robot. Rotational forces or movements control or primarily control wrist. Translational forces, up, down, side to side, may control movement of actuators from the base of the Scara to wrist. The actuators may be very quick acting. Sensitivity of the hand control may be set by the operator. In a safety mode, motion controller 24 may have a programmed instruction that at any time the robot arm at the end effector 16 or at hand control position receives a reverse motion command, the robot will stop momentarily (pause) at zero speed position. This prevents an instantaneous reverse. The length of pause at the stop may be controlled. When there is reverse motion, the motion controller 24 may stop all motion, or stop motion in the current movement direction, or stop movement in the opposite direction. As an alternative to a set pause, the controller 24 may stop all motion until the operator moves the hand control back to a neutral position, at a position where the hand control is not generating any commands to the controller.

If there is a spring in the hand control that biases the hand control to a neutral position in both translational and rotational directions, the operator can tell from the forces about where the neutral position is. The operator may also release the hand control when there are springs in the hand control so that the hand control moves automatically to neutral position. In another failsafe mode of operation, if sensors on the robot arm detect an excessive force, speed change or rapid change in direction, the controller 24 may be configured to stop all actuators. In operation, the operator gains skill in moving the control arm learns to avoid unintentional movement. If the operator accelerates the arm and payload, and decelerates so that the end effector 16 reverses direction, the controller 24 may be configured to send a command to stop all motion and the operator must let go of hand control. When the hand control returns to neutral position via springs and robot has stopped moving or has reached low enough level of oscillation, an indicator light or audible signal allows the operator to hold on to the hand control. In general, when approaching a specific position, for example a neutral position, the controller 24 and the operator should slow movements to avoid overshoot.

Control wires and power wires may go through the middle of the robot arms. For cooling, air may be drawn through the hollow centres of the arms and may be released to atmosphere through the base. The air may be blown with a pressurized air system or drawn through with vacuum located anywhere on robot. Base may be secured to surface by vacuum for simplicity with a pump on top of the Scara. The Scara needs to be relatively stiff in torsion because the robot lifting arm might be at 90° to the Scara. There may be any number of arms on the Scara. The base of the robot lifting arm may be angled away from structure (FIG. 8A), which allows a different range of motion than if horizontal.

The actuator control may be a servo feedback control or closed loop, or stepper motor with open loop control. A closed loop needs feedback with an encoder, which is more expensive and complex but results in more precise control and higher efficiency. Side to side motion is controlled by Scara arm actuators A1-A4, which are typically larger than the shoulder S1, elbow E1 or wrist W1 actuators. Larger actuators allow higher step count, so more than the combination 96 poles with 92 posts. The stepper motor steps are not necessarily discrete, but may use microsteps as known in conventional stepper motors. The current control for step to step may be proportional to the movement of the hand control.

The system may be mass and inertia compensated so the operator feels the weight or inertia of a load. The system does scale motions of the operator to the load. The spring force on the hand control, if present, may be varied by haptic feedback to the controller 24. If the payload is being connected to something, the controller 24 may sense contact and send signal to the hand control. If the hand control is located at or near the wrist, it is expected that mechanical vibration of the payload will be experienced by the operator. It may be beneficial for the operator to have their forearm rest on the robot on the arm rest of FIG. 7 for example. The arm rest may be rigidly fixed to the robot arm or rotationally fixed with or without a spring and damper. Thus, the operator only needs to control wrist and not arm. The forearm rest may be configured to allow the arm to be easily removed from the rest, for safety and comfort, for example using upwardly open curved or cup shaped rests 94. There may be vibration sensor at or near the end effector 16 that sends feedback to the hand control or give audible signal to ear bud, which may be useful in noisy environments. While it is important to avoid damage to surroundings, for example by the auto stop feature, that excitation prevention strategy may be applied only above certain speed.

A base actuator of any one of the sets of actuators may have vertical orientation, or parallel to main force being acted against. For rotation about the y axis, in a simplified control mode of operation, the array of wedges in a wrist W2 may start with a vertical axis, downstream of the hand control. The first actuator 30 may be the only actuator responsive to a rotation about the y axis of the hand control. In this case, the actuator stack of wrist W2 stays in plane and rotates, every second actuator in one direction, every first actuator except the actuator 30 oppositely, which causes a near rotation about the y axis, and at the same time the end effector 16 lifts, which results in a need to change the elbow E1 or the shoulder S1. The operator does this naturally by moving hand forward and change height a bit, which adjusts the shoulder and the elbow. The manner of control about the y axis may be operator selected, for example by (1) rotation of base actuator A1 only (eg when operator paints in cylinder) (2) base actuator A1 rotates in one direction, base actuator A4 of shoulder rotates in opposite direction or (3) base actuator A1 rotates one direction and shoulder actuator A4 in same rotation. These controls may be speed control, with a pre-set response of each actuator in relation to a preceding actuator, so that all actuators rotation in proportion to each other in master-slave relation. The proportion could be programmed with a simple algorithm, or the controller 24 could be set to modify the proportion based on the position of the robot arm.

For example, with a vertical lift of the hand control: the elbow E1 extends, the wrist W1 rotates in proportion to the elbow so that the vertical actuator stays vertical, the user naturally moves hand control (reaction translation of hand control) in a way that the shoulder S1 moves because the Scara moves, which changes the angle of the elbow E1. There is an ideal rotation of the wrist W1 to keep the vertical axis actuator vertical. The actuator need not be perfectly vertical, so in some cases there may be no need to move shoulder S1. If the shoulder S1 horizontal axis actuator stack or equivalent horizontal axis actuator is not present, the elbow E1 and the wrist W1 may be necessary, depending on the application. In some embodiments, the vertical lift function of shoulder S1 may not be needed.

The end effector 16 grip and ungrip functions may be controlled by a trigger on the hand control for example using a driver 28. If the rotary wedges of a joint introduce an unintended side to side motion of the end effector 16 if they are not rotating perfectly in unison, a closed loop feedback may be needed in the rotary wedge joints. Another embodiment could use one or more wedge sets that could be closed loop which could be used on their own for very fine movements. When stepper motor control is used, individual sets of two or three wedges could be added or subtracted from the array or stack of wedges, such that the finer the movement required, the more sets that would be activated.

In an embodiment, a change in hand control angle results in a proportional change in angle of the end of the wrist. If a predetermined hand control angle is exceeded in a direction (different directions can have different limits which correspond to the limits of the range of angular motion of the human operator) the end of the wrist may change from an angular displacement mode to an angular speed mode past a predetermined limit. The hand control may rotate at the same speed and angle as the end of the wrist W1 so the hand control will be aligned in the neutral position of the robot wrist when the speed rotation command is over and the hand control is returned by the operator to the neutral position.

If three sets of wedges are used, the array would be able to rotate in any direction at any time. The neutral position would be with each set at 120° to each other. Then one or more actuator sets can be rotated to bend the whole assembly in any direction. If the wedges are greater angle than necessary for the desired assembly range of motion, the wedges can be used at less than 180° rotation. The wedges may be controlled to have hard stops or possibly sprung stops between wedges for various effects such as using spring force to reduce the actuator torque when supporting off-plane motions with a payload.

In any one of the actuators, a certain level of friction may be advantageous for the stepper motor control because it prevents the actuators from jumping from step to step. With no friction, there is only inertia to prevent the actuator from jumping from one discrete step to the next. With a certain amount of non-stick-slip friction (such as is common to a preloaded roller bearing, or a Teflon™-on-Teflon™ sliding contact) there is a certain level of current that is required to overcome this friction. Embodiments of the actuator use magnetically preloaded bearings which may provide the necessary non-stick friction to the actuator providing a smoother transition from step to step.

In another embodiment, shown in FIG. 6, bearings 76 and 78 may be used in combination with a low friction surface combination between the stator 72 and rotor 74 such as, but not restricted to, in the airgap. Teflon™ on Teflon™, for example, as very low stick-slip-friction and would allow smooth operation of the actuator in stepper mode by requiring a high level of torque from the actuator to overcome this friction. A material like Teflon™ has a unique characteristic which allows micro movements to be achieved through a variation of force on the movable structure which is rotationally or otherwise movably attached to the fixed member.

In the robot arm with the elbow joint E1 and the shoulder joint S1, both joints may respond to a vertical translation of the hand control 20. In a more simple operational mode, only the elbow E1 responds to a vertical translation. The shoulder S1 may also respond to a vertical translation but it is a secondary or reaction effect where the horizontal component of the vertical movement that results from the arc movement of the forearm around the elbow axis moves the hand control bracket radially away from the operator and as a result of the operator resisting the movement of the hand control radially, a horizontal (and radial) displacement of the hand control occurs relative to the arm. This relative horizontal movement of the hand control has a pre-set response.

In other words, the vertical displacement for the hand control results in an extension of the elbow E1 only. The extension of the elbow E1 may result in a horizontal movement of the hand control connection to the robot arm (hand control base). When the hand control base moves horizontally with the robot arm, it results in a displacement of the hand control relative to the hand control base. This secondary effect may send a retract command to a different set of actuators that retracts, for example, the Scara and/or shoulder S1.

Or, in other words, the elbow joint E1 may respond vertical displacement of the hand control by extending until it corrects the error. That is, the extension of the elbow E1 acts to bring the hand control back to zero displacement in the vertical direction. The horizontal movement of the robot arm at the hand base (relative to the operator) creates a secondary error in the horizontal direction which results in a retract command to one or more actuators that respond according to a predetermined relationship to correct the horizontal error. Other tertiary, quaternary etc. errors may result in other directions, but with all of the possible translational planes linked to one or more actuated joints, the various sets of actuators will move in unison but independently of each other to approximate the trajectory of the hand control. It is understood that the arm, in this example, will be displaced initially in an unwanted direction before the horizontal error registers at the hand control 20 and in the controller 24, but it is believed that the operator will learn to compensate for this imperfect motion path and may even learn to anticipate it to prevent it from happening at all.

The cogging steps of an actuator are not necessarily the same as the powered steps that result from the commutation of the electromagnets.

FIG. 10A shows a stack of exemplary wedges 142 in a wedge stack, here with three actuators and four wedges 142. Each actuator comprises a stator 144 and rotor 146, which each can be made according to the designs disclosed in this patent document, preferably axial flux hollow interior actuators held together with magnetic forces using pre-loaded bearings 148 (only the races are shown, ball bearings are not shown) and with a locking or safety ring 150 on an outside or inside perimeter of the actuators. FIG. 10B shows a detail of FIG. 10A with the stator 144, showing coils, and rotor 146 that has magnets.

FIG. 11A shows a section through two adjacent wedges 142 held together also by a safety ring 150, and having an actuator formed by stator 144 and rotor 146 combined. A stator and rotor combination on each opposing face will therefore be at an angle corresponding to the angle of the wedge. Each opposing face defines a plane that the stator-rotor combination rotates in. Rotor 146 has posts that hold magnets in the rotor and a unitary backiron. Stator 144 has coils around posts and a unitary back iron.

FIG. 11B is an exploded view of two wedge housings 143, showing an actuator 145 formed of stator 144 and rotor 146, and safety ring 150. Each housing 143 may be a unitary element. The angle of the wedge housing 143 can be seen in FIGS. 11A and 11B.

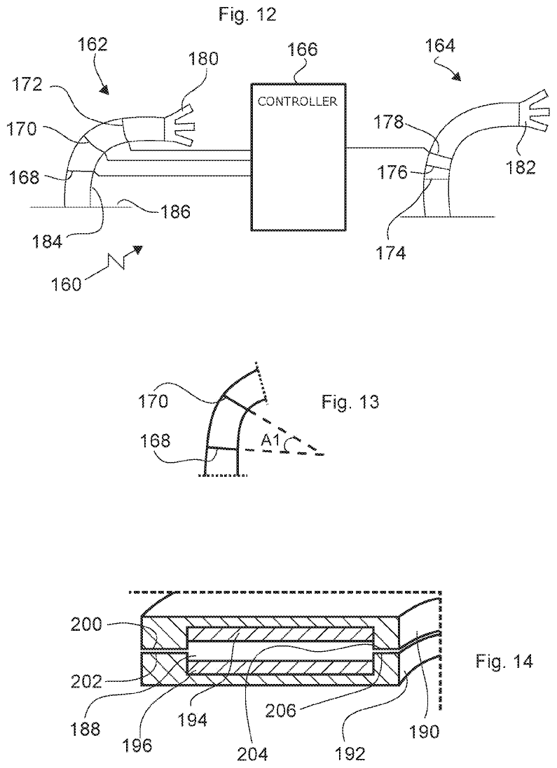

Referring to FIG. 12, there is shown a robot system 160 comprising a slave robot arm 162 and a master robot arm 164. The slave robot arm 162 comprises actuators, including at least a first actuator 168 that rotates in a first plane, a second actuator 170 that rotates in a second plane and a third actuator 172 that rotates in a third plane. Each plane is perpendicular to the plane of the figure and the line in the figure that represents each actuator lies within the plane corresponding to the actuator. As illustrated in FIG. 13, for the case of actuators 168 and 170, the first plane is at a first angle A1 between zero and 90 degrees from the second plane. Likewise, the second plane is at a second angle A2 between zero and 90 degrees from the third plane.

The master robot arm 164 comprises actuators, including at least a fourth actuator 174 that rotates in a fourth plane, a fifth actuator 176 that rotates in a fifth plane and a sixth actuator 178 that rotates in a sixth plane. Each plane is perpendicular to the plane of the figure and the line in the figure that represents each actuator lies within the plane corresponding to the actuator. As illustrated in FIG. 13, for the case of actuators 168 and 170, the fourth plane is at a third angle A3 between zero and 90 degrees from the fifth plane and the fifth plane is at a fourth angle A4 between zero and 90 degrees from the sixth plane.

Each actuator may be made in accordance with the actuator described herein, or as described in US published patent application US20170338705 or as described in US20170187254, both of which are incorporated herein by reference where permitted by law.

Each of the actuators 168, 170 and 172 may be comprised of a respective stator and rotor pair, and each stator and rotor pair is provided with sufficient friction between the stator and rotor that the stator and rotor do not move relative to each other under normal operational loads without being energized. The friction between each stator and rotor pair may be provided for example by loaded bearings or sliding bushing surfaces, for example by friction between the safety ring 121 and the rotor 201. The friction between stators and rotors of the master robot arm need not be so limited.

A robot controller 166 is responsive to positioning of one of the actuators 174, 176 and 178 to control the position of at least the actuators 174, 176 and 178. Lines connecting the robot controller 166 to the slave robot arm 162 and master robot arm 164 depict unidirectional or bidirectional communication channels that may be any conventional communication channel including wireless, optical and wired. The actuators may include encoders, not shown, that provide signals to the robot controller that are indicative of position of the actuators. The robot controller includes a memory, microprocessor, drivers for the actuators and interfaces for the encoders, as well as a user interface. These elements are conventional in robot controllers and are not separately described.

In one mode of operation, the robot controller 166 is responsive to positioning of the actuator 176. In this mode of operation, the actuator 176 is not driven by the robot controller 166, but is responsive to movement of the robot arm 164 for example by an operator, who may be a surgeon, manipulating an end effector 182 at the end of the robot arm 164. The end effector 182 may include a surgical instrument. As the end effector 182 moves, the actuators 174, 1764 and 178 begin to move relative to each other. The robot controller 166 responds to positioning, in this example, of the second actuator 176 to drive the actuators 174 and 178. In addition, the robot controller 166 drives the actuators 168, 170 and 172 in a corresponding manner. In one mode of operation, the corresponding manner is to effect scaling of the movement of an end effector 180 with the movement of the end effector 182. Thus, for example, if the end effector 182 is moved through a given amount, then the end effector 180 may be driven a fraction of the given amount. The operator therefore may use a coarser movement at end effector 182 to cause a finer movement at end effector 180. This scaling effect may smooth out non-linearities in the control system.

The scaling function may be provided by selecting the angles between the planes of the actuators of the master robot arm to be a fraction of the angles of the planes of the actuators of the slave robot arm. Thus, A3 may equal R1×A1, where R1 is a fraction between 0 and 1, and A4 may equal R2×A2, where R2 is a fraction between 0 and 1. R1 may equal 1/N1 for some natural number N1, for example N1=10, and R2 may equal 1/N2 for some natural number N2, for example N2=10. In an example, A1=A2, A3=A4 and N1=N2. In a further example, A1=A2=30 degrees, and A3=A4=3 degrees, which effects a 10:1 scaling of the slave robot arm 162 to the master robot arm 164.

Each actuator may comprise a hollow, axial flux actuator, and drive signals from the robot controller 166 may be provided to the actuators 168, 170 and 172.

The robot controller may be configured to drive the actuators oppositely alternately.

The angle of an actuator relative to an adjacent actuator may be referred to as a wedge angle. The arms between actuators effectively form wedges. An actuator may have a wedge angle as low as 1 degree or lower. Bearing friction in each slave actuator may be set to make the slave actuators non-backdrivable in the load bearing direction in any position of the wedges. The friction should be non-stick-slip friction. Commutation of the electromagnets in the actuators with smooth current profiling allows a smooth ramp up force against friction.

The friction in the actuator may arise for example from ball bearing friction resulting from axial magnetic forces on the bearings. For this purpose, a radially rigid roller bearing preloaded in axial and radial direction by magnetic force may be used. The friction may also be created by sliding contact or bushing for outer bearing or could be sliding contact between stator and rotor posts, or an embodiment may have layer of Teflon™ or the like coating on the rotor and stator, for example there may be carbon coating, or other smooth surface bearing against smooth surface. A material such as Teflon™ that has lower static friction than dynamic friction may be used for the rotor to stator smooth surface contact. Another possibility for a contact material between rotor and stator is spinodal bronze, though it is less ideal for medical purposes because it is red. An opposed surface becomes coated with nickel that migrates out of bronze coating. An example of an actuator with a sliding contact bearing surface is shown in FIG. 14. Carriers 190 and 192, one of which is a stator and the other a rotor, have electromagnetic elements 194 and 196 respectively mounted opposed to each other for electromagnetically driving the rotor with respect to the stator. At least one of the sets of electromagnetic elements 194 and 196 is commutated electrically. The drawing is not to scale. In practice, air gap 198 can be very small. The drawing is a section through one side only of a hollow annular axial flux electric machine. Sliding bearing surfaces 200, 202, 204 and 206 as discussed here may contact each other and provide friction for the actuators in the slave robot arm 162.

In the determination of bearing friction, the designer calculates the maximum payload, and designs the actuators so that friction coefficient and axial preload result in higher resistance than torque resulting from the maximum payload. The friction requirement may be reduced by using a rotating wedge configuration. Thus, for example, a 1 degree angle wedge requires very low friction force to ensure rigidity when power is lost. The angle of the wedges may be matched to the coefficient of friction and axial force on actuators.

Although a design is shown in FIG. 12 with a shoulder 184 resting on a support 186, for example a table, there may also be an elbow or wrist as shown in other embodiments of a robot arm disclosed herein.

The wedge sets may have more than two wedges, and therefore more than three actuators. The wedges in a stack rotate oppositely so that if the first wedge of a pair rotates clockwise, the second wedge of the pair rotates counter clockwise. If the master robot arm 164 has N wedges then each odd wedge may rotate clockwise and each even wedge may rotate counter clockwise. The even wedges may rotate the same amount as each other and the odd wedges may rotate the same amount as each other. An amount is an angle. In the master robot arm, only one actuator need not be driven, the other actuators in the master robot arm may be slaved to the one actuator. The operator moves just the end effector and does not need to know which actuator is not slaved. The operator may also be provided with a switch to disable one or more actuators and move only a specific actuator. For example, the operator may disable actuators 174 and 176 and rotate only actuator 178. The signal from the actuator 178 may then be used to drive the corresponding actuator 172. In this instance, if the actuators 168 and 174 are parallel to the support 186 and the support is horizontal, this motion corresponds to a rotation about a vertical axis of each entire robot arm. The actuators in a wedge stack may all rotate in unison.

Motion of the actuators 168-178 may be impeded when all actuators are aligned with the thinnest part of the wedges all in the same plane as the load (wedges at top dead centre, which corresponds to a rotational position of zero or 180 degrees, that is, two different positions). Therefore, the actuators 168-178 may be restricted from being at rest at top dead centre by a physical stop or software stop, for example at about 5 degrees from top dead centre. The actuators in a stack of actuators for example actuators 168-178 and the corresponding wedges may rotate up to about 180 degrees, but may be restricted to travel of about 160 degrees or 170 degrees, for example from 5 degrees off top dead centre to about 175 degrees off top dead centre. With restricted angular motion, wires to carry power and drive commands, as well as sensor or encode signals, may be provided from one actuator to another through the hollow interior of the robot arms.

A force sensor or transducer (not shown) may be provided at the end effector of the master robot arm 164 to detect the payload force, and send a signal back to the robot controller 166. The robot controller 166 may be configured to sense the force sensor signal and drive the actuators 174-178 to provide a controlled feedback or haptic force to the operator. The force transducer sends a signal to the robot controller, which determines which slave actuators need to be energized to reproduce the payload force.

According to this system, an angular motion of X degrees by the operator may correspond to an angular motion of X/R degrees where R may be a natural number, for example 10 where the wedge angle of the slave is 10 times the wedge angle on the master. Another possibility is to use stepper motors for the actuators in which 10 steps at the slave robot arm equals one step at master. However, change of angle to change of angle control is desirable. The slave arm joints may have the same range of motion and axes as master joints. Thus, actuators in the slave robot arm 162 may rotate the same number of degrees as the actuators in the master robot arm 164. The scaling effect is provided by the different wedge angles.

In an example, the slave robot arm 162 may have two wedges at a 30 degree angle with three actuators and 10 wedges on the master robot arm 164 at 3 degrees. The designer may choose the number of wedges to be driven. Thus, the operator holds the end effector, the arm extends, the angles detected by encoders and sent to the robot controller 166.

In a series of three actuators, the first and third may rotate half the angle of the second actuator, but oppositely. A rotational command from the second actuator may cause the same angle rotation on the second master actuator.

If the actuators in an arm are wired in series, to make only a half turn for the end actuators, a separate motor controller for the end actuators may be used or the drive signal may be conditioned by a device at the end actuator.

If three sets of wedges are used, the array would be able to rotate in any direction at any time. The neutral position would be with each set at 120 degrees to each other. Then one or more actuator sets can be rotated to bend the whole assembly in any direction.

If the wedges are greater angle than necessary for the desired assembly range of motion, they can be used at less than 180 degree rotation. They may allow using hard stops or possibly sprung stops between wedges for various effects such as using spring force to reduce the actuator torque when supporting off-plane motions with a payload.

A certain level of friction may be advantageous for stepper motor control because it prevents the actuators from jumping from step to step. With no friction, there is only inertia to prevent the actuator from jumping from one discrete step to the next. With a certain amount of non-stick-slip friction (such as is common to a preloaded roller bearing, or a sliding contact such as a Teflon™-on-Teflon™ sliding contact) there is a certain level of current that is required to overcome this friction. Embodiments of the actuators use magnetically preloaded bearings which provide the necessary non-stick friction to the actuator providing a smoother transition from step to step.

In another embodiment, ball bearings can be used in combination with a low friction surface combination between the stator and rotor such as, but not restricted to, in the airgap. Teflon on Teflon, for example, as very low stick-slip-friction and would allow smooth operation of the actuator in stepper mode by requiring a high level of torque from the actuator to overcome this friction. A materials Teflon has a unique characteristic which allows micro movements to be achieved through a variation of force on the movable structure which is rotationally or otherwise movably attached to the fixed member. Instead of stopping robot with change of direction, with change of direction command to actuator, all actuators may stop momentarily.

In any stack of actuators and wedges disclosed in this patent document, in a given set of robot arm movements, a first movement stage may involve rotation of a first set of wedges, and a second movement stage may involve rotation of some or all of the first set of wedges. The wedges may be in counter-rotating pairs which are active in both the first movement stage and the second movement stage. In a specific example, the second movement stage may involve a smaller number of actuators and wedges, such as a single pair of wedges. For example, if the first movement stage involved rotation of 6, 8, 10 or 12 wedges, the second movement stage may involve a single pair of wedges counter-rotating relative to each other. Since involvement of each actuator may lead to a loss of precision in the robot arm movement, this method may allow increased precision in the second movement stage. In general, any movement stage could also be followed by additional movement stages, with each movement stage involving a different number of actuators, with corresponding lower or higher precision. A movement stage could correspond to a specific movement of a robot arm towards an object, and a subsequent movement stage could correspond to a subsequent movement, such as grasping or positioning an object. A movement stage could correspond to a time period, with different movement stages occurring during specified time segments. Opposite movement of the wedges may be equal angular amounts or speeds or different angular amounts or speeds.

The same principles of hand control controlling a rotary actuator may be applied to a linear actuator. For example, rotation angle of hand control may be sensed to drive a proportional displacement of any linear actuators downstream of the hand control For example, displacement of hand control may be sensed to drive proportional speed of any linear actuators upstream of the hand control.

In some embodiments, any number of wedges can be used, for example odd numbers can work, especially if there is a half angled wedge at the top and bottom. So for example, a 5 degree wedge at the bottom, a 10 degree wedge in-between, and a 5 degree wedge at the top works to increase mechanical advantage and to provide a controlled motion. Any other number of wedges will work as well.

In the claims, a reference to claims 1-N means any one of claims 1-N, where N is a positive natural number.

1-101. (canceled)

102. A robot arm configured as a scara arm, comprising:
a base actuator having a base adapted to be secured to a planar surface;
a first link extending away from the base, the first link being connected to the base by an actuator having a first axis perpendicular to the first link; the first link including a second actuator having a second axis parallel to the first axis;
a second link coupled to the second actuator; and
the first or the second link includes a bearing element that is configured to move along the planar surface when the base actuator is secured to the planar surface.

103. The robot arm of claim 102 wherein the axes of the actuators are vertical.

104. The robot arm of claim 102 or 103 wherein the planar surface is horizontal.

105. The robot arm of claim 102 wherein the actuators are axial flux actuators.

106. The robot arm of claim 105 wherein the actuators have a hollow design for allowing wires to pass therethrough.

107. The robot arm of claim 102 wherein the second link is an end link.

108. The robot arm of claim 102 wherein the base actuator is configured to be fixed to the planar surface via a vacuum.

109. The robot arm of claim 102 wherein the bearing element is arranged to roll on the planar surface.

110. The robot arm of claim 109 further comprising an intervening link between the first link and the second link.

111. The robot arm of claim 110 wherein the axes define an axial direction, the first link, the second link and the intervening link are stacked in the axial direction and the first link includes the bearing element.

112. The robot arm of claim 110 wherein the first link and the second link are disposed on the same side of the intervening link.

113. The robot arm of claim 112 wherein the first link and the second link are arranged to be between the intervening link and the planar surface when the base actuator is secured to the planar surface.

114. The robot arm of claim 102 in which the second link includes the bearing element.

115. The robot arm of claim 114 in which the first link includes a second bearing element.

116. The robot arm of claim 102 further comprising a controller configured to cause the actuators in the robot arm to rotate alternately oppositely and the end link to translate.
